(19) United States
(12) Patent Application Publication
(10) Pub. No.: US 2026/0241212 A1
(43) Pub. Date: Aug. 20, 2026

(54) Advanced Fire Blanket

(71) Applicant: Michael Fishman, Parkland, FL (US)

(72) Inventor: Michael Fishman, Parkland, FL (US)

(21) Appl. No.: 19/643,902

(22) Filed: Apr. 10, 2026

Related U.S. Application Data
(63) Continuation-in-part of application No. 19/044,076, filed on Feb. 3, 2025.

(51) Int. Cl. A62C 3/02

(52) U.S. Cl. CPC A62C 3/0257

(57) ABSTRACT

A fire blanket comprising a woven fiberglass fabric constructed from continuous fiberglass filaments having an average diameter of approximately 9 micrometers is disclosed. The woven fabric is treated with an acidic solution having a pH between approximately 3.0 and 4.5 to remove surface impurities, reduce surface roughness, and reduce the presence of loose or sharp fiberglass particles. The fabric is subsequently heat treated at an elevated temperature to enhance fiber stability, reduce brittleness, and improve flexibility and draping characteristics. The fire blanket may include reinforced edges, hand-pull straps, and optional weight elements to improve deployment and positioning during use. The resulting fire blanket provides improved handling, reduced fiber shedding, and enhanced fire suppression performance.

### BACKGROUND OF INVENTION

Fire blankets are commonly used for fire suppression in residential, commercial, and industrial environments. These blankets function by covering a fire and reducing the amount of oxygen available to the combustion zone, thereby extinguishing or controlling the flames. Conventional fire blankets are typically constructed from woven fiberglass fabrics due to their heat resistance and durability.

However, existing fiberglass fire blankets present several limitations. Many conventional blankets are manufactured using fiberglass filaments with relatively larger diameters, which can result in a coarse surface texture. This coarse structure may lead to the presence of loose or sharp fiberglass particles, which can cause irritation during handling and reduce user comfort. Additionally, untreated fiberglass fabrics may exhibit higher surface roughness and fiber shedding, which can negatively impact usability and perceived quality.

Another limitation of conventional fire blankets is that the fiberglass material may retain surface impurities from the manufacturing process. These impurities can contribute to inconsistent surface characteristics, reduced flexibility, and less effective draping over irregular fire sources. Poor draping can create gaps between the blanket and the fire source, allowing oxygen to reach the combustion zone and reducing the effectiveness of the blanket.

While various fire blanket designs have been developed, including those incorporating weights or reinforced edges to improve positioning and stability, such features do not address the underlying material characteristics of the fiberglass fabric itself. As a result, there remains a need for a fire blanket that provides improved surface smoothness, reduced fiber shedding, enhanced flexibility, and improved handling characteristics.

Accordingly, there is a need for a fire blanket constructed from fiberglass material that has been processed to reduce surface impurities, minimize sharp or loose fiberglass particles, and improve overall performance during fire suppression.

### BRIEF DESCRIPTION OF THE DRAWINGS

The accompanying drawings illustrate various embodiments of the fire blanket and its components.

FIG. 1 illustrates a perspective view of a fire blanket showing the main blanket body (180), at least one hand-pull strap (160), and a reinforced edge (165) extending along the perimeter of the blanket.

FIG. 2 illustrates a cross-sectional view of one embodiment of a weighted fire blanket (190), showing a weight (121) positioned within a pocket (130) and secured by stitching (149).

FIG. 3 illustrates a side view of the weighted fire blanket (190), showing the placement of the weight (121) within the pocket (130) and the stitching (149) securing the structure.

FIG. 4 illustrates a top perspective view of a weighted fire blanket (190), showing multiple weights (121), pockets (130), hand-pull straps (171), and reinforced edges (170).

FIG. 5 illustrates another embodiment of a fire blanket (401) having distributed weights (121) positioned within pockets (130) along the blanket, along with at least one hand-pull strap (160).

FIG. 6 illustrates an embodiment of a fire blanket (501) having a rolled edge (510) forming a weighted perimeter, along with at least one hand-pull strap (160).

### DETAILED DESCRIPTION OF THE INVENTION

The present invention relates to a fire blanket constructed from a woven fiberglass fabric designed to provide improved fire suppression, durability, and ease of handling. The fire blanket is formed from continuous fiberglass filaments, which in certain embodiments have an average diameter of approximately 9 micrometers, resulting in a softer, more flexible material compared to conventional fiberglass fire blankets.

In one embodiment, silica-based material is melted at high temperature to form molten glass, which is subsequently processed into glass beads and drawn into continuous fiberglass filaments. The filaments are then woven into a fiberglass fabric using a weaving process to form a fire blanket substrate.

Following the weaving process, the fiberglass fabric is treated with an acidic solution having a pH between approximately 3.0 and 4.5, and more specifically about 3.6. The acidic treatment is performed after the fabric has been woven and is sufficient to remove surface impurities and reduce the presence of loose or sharp glass fragments on the surface of the fibers.

After the acidic treatment, the fabric is dried and subsequently subjected to a heat treatment at a temperature of approximately 300° C. The heat treatment enhances fiber stability, reduces brittleness, and improves flexibility and draping characteristics of the fabric.

As a result of the acidic treatment and subsequent heat treatment, the fiberglass fabric exhibits improved surface smoothness, reduced fiber shedding, and enhanced handling characteristics. The treated fabric also demonstrates improved draping ability, allowing the fire blanket to conform more closely to a fire source and more effectively limit oxygen flow to the combustion zone.

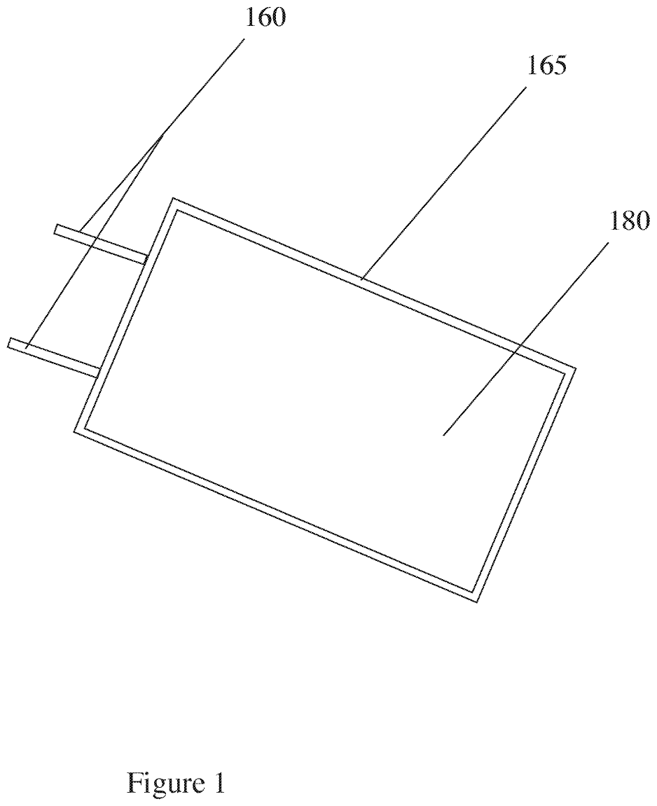

Referring to FIG. 1, a fire blanket (180) is shown comprising a woven fiberglass fabric as described above. The blanket includes at least one hand-pull strap (160) attached to the blanket to facilitate rapid deployment. The perimeter of the blanket includes a reinforced edge (165), which may be formed by double stitching, heat sealing, or other reinforcement methods to prevent fraying and improve durability.

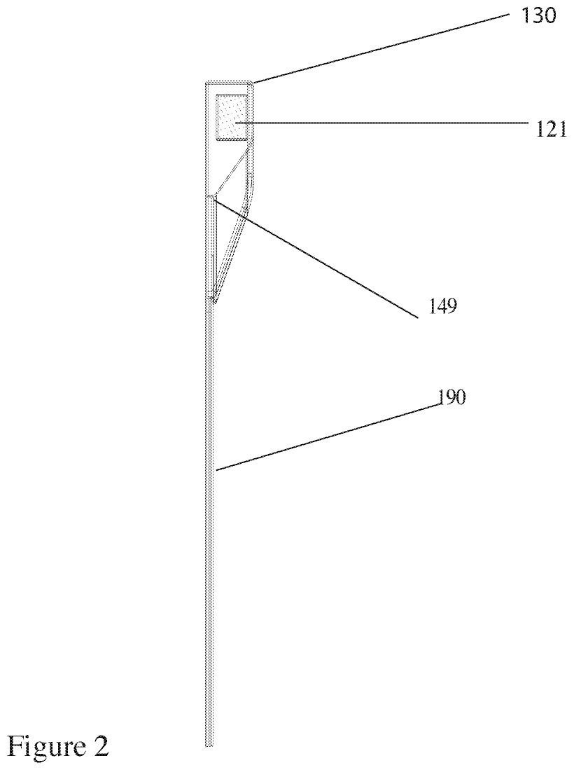

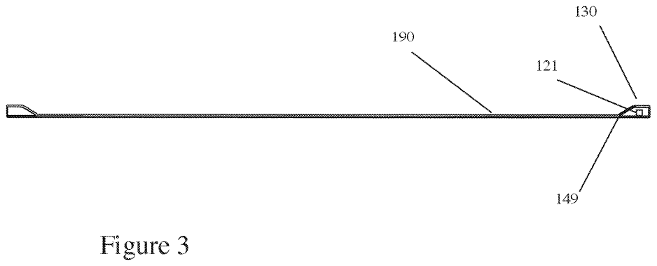

Referring to FIGS. 2 and 3, one embodiment of a weighted fire blanket (190) is illustrated. In this embodiment, a weight (121) is positioned within a pocket (130) formed at a portion of the blanket. The pocket (130) is secured by stitching (149) or other fastening methods to retain the weight (121) in place during handling and deployment. The weight improves the ability of the blanket to remain positioned over a fire source, particularly in environments with airflow or movement.

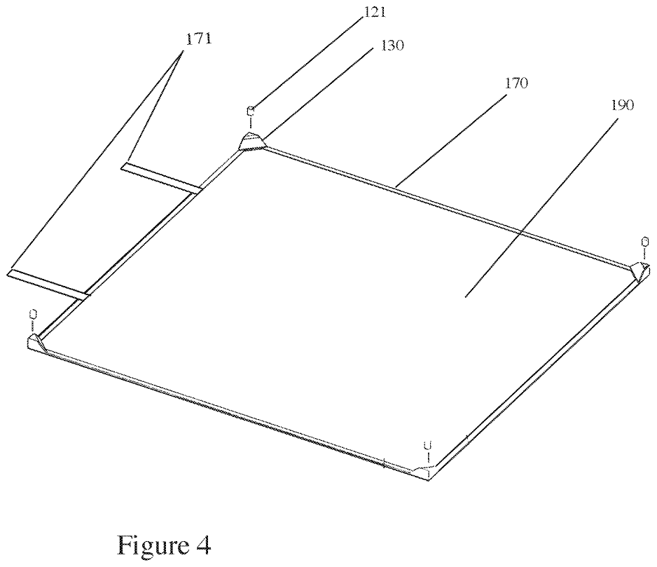

Referring to FIG. 4, a fire blanket (190) is shown with multiple weights (121) positioned at selected locations, including corners or along the perimeter of the blanket. The blanket further includes hand-pull straps (171) and reinforced edges (170). The distributed weights enhance stability and allow the blanket to more effectively conform to the surface of a fire source during use.

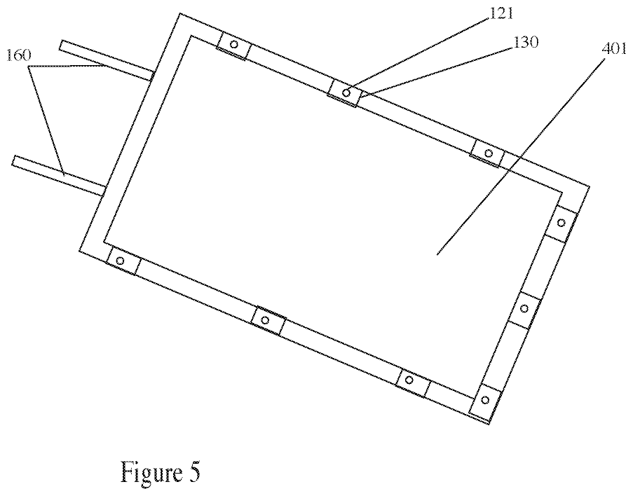

Referring to FIG. 5, another embodiment (401) is shown in which weights (121) are distributed along portions of the blanket within pockets (130). This configuration provides balanced weight distribution across the blanket while maintaining flexibility and ease of handling. At least one hand-pull strap (160) is included to assist with deployment.

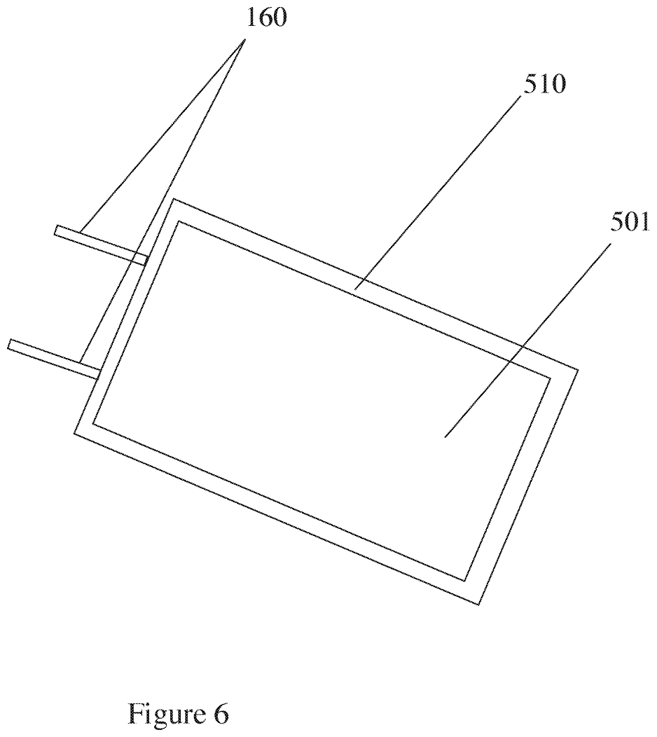

Referring to FIG. 6, a fire blanket (501) is shown having a rolled edge (510) extending along the perimeter. The rolled edge forms an integrated weighted structure without requiring separate inserted weights. The rolled edge may be secured using stitching, heat sealing, adhesive bonding, or combinations thereof. At least one hand-pull strap (160) is also included in this embodiment.

While specific embodiments of the fire blanket have been described, it will be understood that variations in materials, dimensions, and configurations may be made without departing from the scope of the invention. The fiberglass fabric may be produced using different weaving methods, including shuttleless looms, air-jet looms, or other suitable weaving systems, provided that the resulting fabric maintains sufficient strength and fire-resistant properties.

The acidic treatment described herein may be performed using various acidic solutions within the disclosed pH range, and processing conditions such as treatment time, temperature, and drying methods may be adjusted as needed to achieve the desired removal of impurities and improvement in fiber surface characteristics. The subsequent heat treatment may also be varied in temperature and duration, provided that it enhances fiber stability, flexibility, and durability.

The weights described in the various embodiments may be formed from different heat-resistant materials, including but not limited to ceramic, stainless steel, tungsten, brass, or composite materials, and may be positioned in different configurations, including corners, edges, or distributed locations across the blanket. The size, number, and placement of the weights may be adjusted to optimize handling and fire suppression performance.

The rolled edge embodiment may be formed using different folding techniques and securing methods, including stitching, heat sealing, adhesive bonding, or combinations thereof, and may incorporate additional reinforcing materials to maintain structural integrity during repeated use.

The fire blanket may be produced in various sizes and shapes depending on the intended application, including residential, commercial, industrial, and emergency response uses. The number, placement, and construction of the hand-pull straps may also vary to accommodate different deployment methods and user preferences.

Although specific features have been described in connection with certain embodiments, such features may be combined with other embodiments or omitted where appropriate. Accordingly, the scope of the invention is not limited to the specific embodiments described, but is defined by the claims that follow.

1. A fire blanket comprising a woven fabric constructed from continuous fiberglass filaments having a diameter between 8.5 microns and 9.5 microns, wherein the fabric is woven in a plain weave structure with a warp density between 16 and 18 ends per centimeter and a weft density between 11 and 13 picks per centimeter, wherein the woven fabric is treated with an acidic solution having a pH between approximately 3.0 and 4.5 sufficient to remove surface impurities, reduce surface roughness of the fiberglass filaments, and reduce the presence of loose or sharp fiberglass particles, wherein the woven fabric is subsequently heat treated at a temperature between approximately 250° C. and 400° C. for a duration sufficient to enhance fiber stability and reduce brittleness, and wherein the fire blanket includes at least one hand-pull strap and a reinforced edge configured to prevent fraying.

2. The fire blanket of claim 1, wherein the acidic solution has a pH of approximately 3.6.

3. The fire blanket of claim 1, wherein the acidic treatment is performed after the woven fabric has been formed.

4. The fire blanket of claim 1, wherein the woven fabric is dried prior to the heat treatment.

5. The fire blanket of claim 1, wherein the heat treatment reduces brittleness of the fiberglass filaments.

6. The fire blanket of claim 1, wherein the acidic treatment reduces the presence of loose or sharp fiberglass particles on the surface of the fiberglass filaments.

7. The fire blanket of claim 1, wherein the woven fabric exhibits improved flexibility and draping characteristics compared to untreated fiberglass fabric.

8. The fire blanket of claim 1, wherein the woven fabric has a thickness between 0.43 millimeters and 0.45 millimeters.

9. The fire blanket of claim 1, wherein the reinforced edge is formed by double stitching using fire-resistant thread.

10. The fire blanket of claim 1, wherein the reinforced edge is formed by heat sealing or adhesive bonding.

11. The fire blanket of claim 1, further comprising at least one weight positioned within a pocket formed in the fabric.

12. The fire blanket of claim 11, wherein the weight is composed of a heat-resistant material selected from ceramic, stainless steel, tungsten, brass, or composite materials.

13. The fire blanket of claim 11, wherein the weight is positioned within a reinforced pocket secured by stitching.

14. The fire blanket of claim 11, wherein multiple weights are positioned at corners of the fire blanket.

15. The fire blanket of claim 11, wherein multiple weights are distributed along a perimeter of the fire blanket.

16. The fire blanket of claim 11, wherein the weights are spaced at regular intervals along the fire blanket.

17. The fire blanket of claim 11, wherein a total weight of the weights is between five percent and fifteen percent of a total weight of the fire blanket.

18. The fire blanket of claim 1, wherein the fire blanket includes a rolled edge forming a weighted perimeter.

19. The fire blanket of claim 18, wherein the rolled edge is secured by stitching, heat sealing, adhesive bonding, or combinations thereof.

20. The fire blanket of claim 18, wherein the rolled edge includes a reinforcing material to maintain structural integrity during use.
